(19) United States
(12) Patent Application Publication
(10) Pub. No.: US 2023/0401462 A1
(43) Pub. Date: Dec. 14, 2023

(54) PREDICTING DEVICE INSULATION CONDITION AND PROVIDING OPTIMAL DECISION MODEL

(71) Applicant: INTERNATIONAL BUSINESS MACHINES CORPORATION, ARMONK, NY (US)

(72) Inventors: Saurabh Trehan, Gurgaon (IN); Pranshu Tiwari, Delhi (IN); Harish Bharti, Pune (IN)

(21) Appl. No.: 17/664,057

(22) Filed: May 19, 2022

(51) Int. Cl. G06N 5/02

(52) U.S. Cl. CPC G06N 5/027; G06N 5/022

(57) ABSTRACT

A method for a predictive insulation condition-based recommendation policy includes determining a present insulation level for an insulation layer on a cable providing power to an electronic device based on a current leakage test. The method also includes determining a current leakage and a confidence score for the insulation layer on the cable providing power to the electronic device utilizing a supervised machine learning model. The method also includes generating a decision framework for the electronic device based on the current leakage and the confidence score in response to determining to perform an action based on the decision framework for the electronic device, the method also includes performing the action based on the decision framework to address the current leakage for the insulation layer on the cable providing power to an electronic device.

### BACKGROUND

This disclosure relates generally to predicting insulation condition, and in particular to providing a recommendation policy based on the predicted insulation condition for an electronic device.

Cable powered electronic devices utilizes an insulation layer that includes both electrical resistance and capacitance, while conducting current through both paths. Current leakage is a phenomenon where current flows from either an AC or DC circuit in an electronic device to a chassis or ground but due to a high level of resistance of the insulation layer, current leakage is typically minimal to nonexistent. However, as the insulation layer for the cable deteriorates due to age and/or unfavorable environmental conditions, the potential for current leakage begins to increase. In addition to potentially damaging sensitive electronic devices, such as medical equipment, the current leakage can potentially present a situation that can shock an individual in a vicinity of where the current leakage is occurring.

### SUMMARY

Embodiments in accordance with the present invention disclose a method, computer program product and computer system for a predictive insulation condition based recommendation policy, the method, computer program product and computer system can determine a present insulation level for an insulation layer on a cable providing power to an electronic device based on a current leakage test. The method, computer program product and computer system can determine a current leakage and a confidence score for the insulation layer on the cable providing power to the electronic device utilizing a supervised machine learning model. The method, computer program product and computer system can generate a decision framework for the electronic device based on the current leakage and the confidence score. The method, computer program product and computer system can, responsive to determining to perform an action based on the decision framework for the electronic device, perform the action based on the decision framework to address the current leakage for the insulation layer on the cable providing power to an electronic device.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart depicting operational steps of an insulation monitoring program, on a server computer within the distributed data processing environment of FIG. 1, for providing a predictive insulation condition based recommendation policy, in accordance with an embodiment of the present invention.

FIG. 3 illustrates an example table of determined current leakage with confidence scores for insulation associated with two devices, in accordance with an embodiment of the present invention.

FIG. 4 illustrates an example table of a decision framework and recommendation policy for determined current leakage and confidence scores, in accordance with an embodiment of the present invention.

FIG. 5 depicts a block diagram of components of the server computer executing the insulation prediction program within the distributed data processing environment of FIG. 1, in accordance with an embodiment of the present invention.

### DETAILED DESCRIPTION

Embodiments of the present invention provide a recommendation policy to predict, test, and recommend insulation thickness of cable powered electronic device for instances of degradation and deterioration. Embodiments of the present invention utilizes a supervised machine learning model and validates with neural networks, linear regression, and selects an optimal model utilizing test data confidence score to predict, test, and recommend actions with regards to the cable powered electronic device experienced a degradation and deterioration of the insulation layer. Embodiments of the present invention create a recommendation policy to assess, repair, or replace an insulation layer where insulation resistance deterioration is present. The supervised machine learning model creates a loss function and utilizes gradient descent optimization to reduce a residual error between observed and actual confidence score to predict, test, and recommend which cable powered electronic device is experience weakened insulation thickness. The supervised machine learning model is trained to study and input various data variables including power readings from a meter sensor, electronic device age, current inflows and outflows, voltage, frequency, temperature, humidity, precipitation, and other environmental variables, such as, CO2 and oxide levels at a location where the electronic device is situated. A distinction over the prior art includes embodiments of the present invention predicting, testing, and recommending a policy based on an aging of an application of the insulation, temperature, humidity, and other environmental variables discussed herein. The supervised machine learning model in conjunction with other validation models, select an optimal model by considering various data variables and testing the statistical difference of each key vector measurement (i.e., aging of an application of the insulation, temperature, humidity, and other environmental variables) that results in the degradation and deterioration of the insulation layer on the cable powered electronic device.

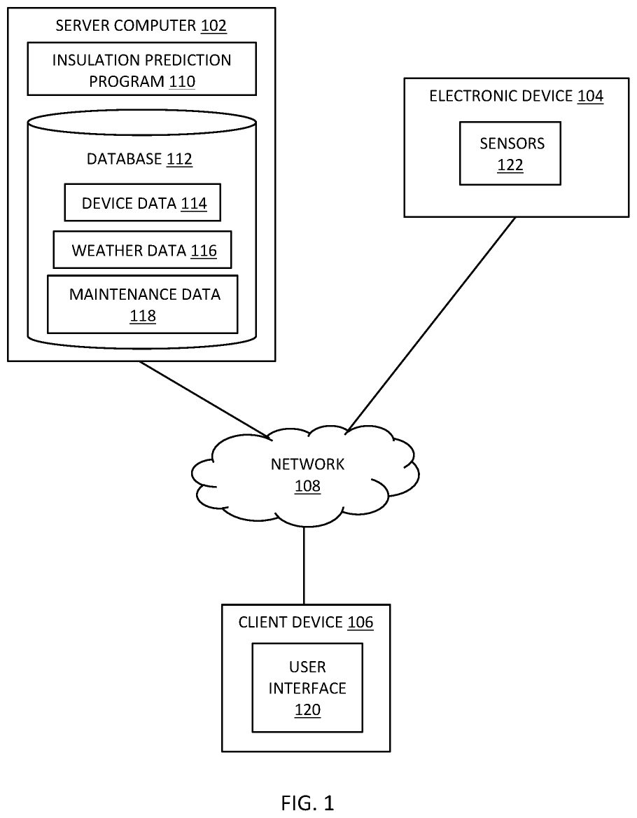

FIG. 1 is a functional block diagram illustrating a distributed data processing environment, in accordance with one embodiment of the present invention. The distributed data processing environment includes server computer 102, electronic device 104, and client device 106 all interconnected over network 108.

Server computer 102 may be a desktop computer, a laptop computer, a tablet computer, a specialized computer server, a smartphone, or any computer system capable of executing the various embodiments of insulation prediction program 110. In certain embodiments, server computer 102 represents a computer system utilizing clustered computers and components that act as a single pool of seamless resources when accessed through network 108, as is common in data centers and with cloud computing applications. In general, server computer 102 is representative of any programmable electronic device or combination of programmable electronic devices capable of executing machine-readable program instructions and communicating with other computer devices via a network. Server computer 102 has the ability to communicate with other computer devices (not illustrated in FIG. 1) to query the computer devices for information. In this embodiment, server computer 102 includes insulation prediction program 110 capable of communicating with database 112, where database 112 includes device data 114, weather data 116, and maintenance data 118.

Electronic device 104 represents a cable powered device, where the cable portion of the powered device includes an insulation layer to prevent current leakage to a surrounding environment. Insulation prediction program 110 predicts a condition and generates a decision framework for the insulation layer of the cable portion of electronic device 104. Electronic device 104 may be an appliance (e.g., air conditioning unit), an industrial equipment (e.g., pick-and-place machine), and medical equipment (e.g., vital sign monitoring station). Electronic device 104 includes various sensors 122 for monitoring various operational parameters for utilization by insulation prediction program 110. Client device 106 may be a cellphone, smartphone, smartwatch, laptop, tablet computer, or any other electronic device capable of communicating via network 108. In general, client device 106 represents one or more programmable electronic devices or combination of programmable electronic devices capable of executing machine readable program instructions and communicating with other computing devices (not shown) within distributed data processing environment via a network, such as network 108. Client device 106 includes user interface 120, where user interface 120 enables a user of client device 106 to interact with insulation prediction program 110 on server computer 102.

Insulation prediction program 110 determines a present insulation level for a cable providing power to electronic device 104. Insulation prediction program 110 can receive the present insulation level for electronic device from an insulation tester (e.g., client device 106) via an insulation resistance typically measure in ohms or megohms. Insulation prediction program 110 determines current leakage with a confidence score for the present insulation of the cable providing power to electronic device 104. Insulation prediction program 110 utilizes historical and real-time usage lifecycle information for electronic device 104, such as, device data 114, weather data 116, and maintenance data 118 to calculate and predict current leakage for electronic device 106 with the confidence score. Insulation prediction program 110 calculates confidence score based on the historical and real-time usage lifecycle information that includes a current leakage value for electronic device 104, a current leakage threshold limit for electronic device 104, an age of electronic device 104, current inflow including voltage levels (Input and Output) for electronic device 104, any prior maintenance actions (e.g., repairs, replacements, previous current leakage tests), and weather information for an environment in which electronic device 104 is located. Insulation prediction program 110 generates a decision framework for electronic device 104 based on the current leakage value and the confidence score and based on the decision framework, insulation prediction program 110 determines whether to perform an action. Performing an action can include altering a customer regarding the insulation level for the cable providing power to electronic device or scheduling a maintenance visit by a technician to perform an assessment, repair, and/or replacement of one or more components with regards to the cable providing power to electronic device 104.

Database 112 is a repository for data utilized by insulation prediction program 110 such as, device data 114, weather data 116, and maintenance data 118. In the depicted embodiment, database 112 resides on server computer 102. In another embodiment, database 112 may reside on client device 106 or elsewhere within distributed data processing environment provided insulation prediction program 110 has access to database 112. Database 112 can be implemented with any type of storage device capable of storing data and configuration files that can be accessed and utilized by insulation prediction program 110, such as a database server, a hard disk drive, or a flash memory. Device data 114 includes various historical and real-time data for electronic device 104 capturable by sensors 122, along with device specification and information for electronic device 104. Device data 114 can include manufacturer specified current leakage threshold limits, manufacturer specified current inflow operational ranges, measured current inflow operational values, manufactured date, and any other data associated with electronic device 104 relating to current leakage. Weather data 116 can include historical and real-time temperature values, humidity values, precipitation type (e.g., snow, sleet), pollution information (e.g., dust, salt), and any other data relating to the environment in which electronic device 104 is located. Maintenance data 118 can include manufacturer specified required maintenance, historical maintenance (e.g., repairs, replacements), prior current leakage tests, and any other data relating to alterations and/or testing performed on electronic device 104.

In general, network 108 can be any combination of connections and protocols that will support communications between server computer 102, electronic device 104, and client device 106. Network 108 can include, for example, a local area network (LAN), a wide area network (WAN), such as the internet, a cellular network, or any combination of the preceding, and can further include wired, wireless, and/or fiber optic connections. In one embodiment, insulation prediction program 110 can be a web service accessible via network 108 to a user of client device 104. In another embodiment, insulation prediction program 110 may be operated directly by a user of server computer 102.

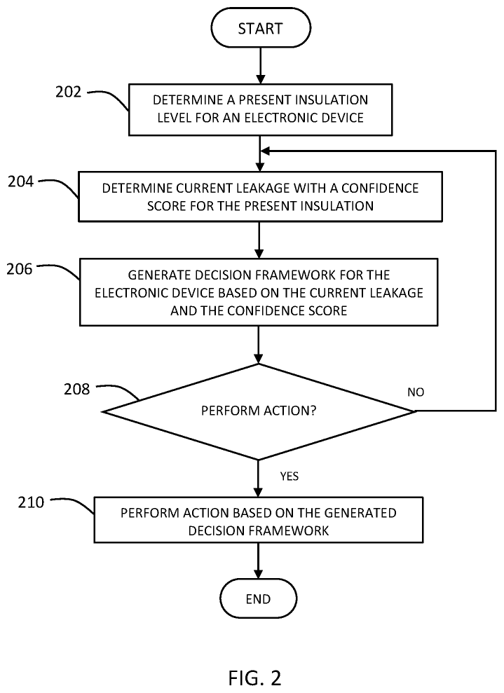

FIG. 2 is a flowchart depicting operational steps of an insulation monitoring program, on a server computer within the distributed data processing environment of FIG. 1, for providing a predictive insulation condition based recommendation policy, in accordance with an embodiment of the present invention.

Insulation monitoring program 110 determines a present insulation level for the electronic device (202). Insulation monitoring program 110 determines the present insulation level for an insulation layer on a cable power the electronic device. As discussed above, electronic device represents any cable powered device, such as an appliance, industrial equipment, or medical equipment. In one embodiment, insulation monitoring program 110 determines the present insulation level for the insulation layer on the cable powered device by receiving resistance values from an insulation tester to perform a Megger test for the insulation layer over a specified period. Insulation monitoring program 110 can receive the resistance values over time represent an initial data set from the insulation tester for the Megger test via a network. Alternatively, insulation monitoring program 110 can instruct a user operating the insulation tester to input an initial data set with the resistance values over time. Based on the initial data set, insulation monitoring program 110 determines the present insulation level for the insulation layer of the cable powered electronic device.

Insulation monitoring program 110 determines current leakage with a confidence score for the present insulation (204). Insulation monitoring program 110 receives various information for the electronic device including but not limited to a manufacture date for determining an age of the electronic device, a location for the electronic device (e.g., outdoors, indoors), temperature values, humidity values, and results from the current leakage test performed with respect to (202). A supervised machine learning model is applied to calculate and predict current leakage with a confidence score for the electronic device. The following are variables utilizes for the supervised machine learning model: let X represent measurement vectors {x₁, x₂, x₃ . . . x_{N}}∈R^{D}, D-dimensional space. Insulation monitoring program 110 utilizes the initial data set to capture and predict electronic device current drawn and leakage values along with a confidence score, where x¹ represents an age of the electronic device based on the manufacture date, x² represents a location of the electronic device, x³ represents a temperature value, x⁴ represent a humidity level value, and x⁵ represents the prior current leakage test performed with regards to (202). Subsequent to insulation monitoring program 110 receiving m-measurements, insulation monitoring program 110 establishes Matrix (m*n), where m is the number of measurement and n is the type of measurement.

Considering the above-mentioned matrix a semi-definite positive matrix, insulation monitoring program 110 utilizes a likelihood criteria to measure y-value utilizing a loss function which can be gradient functions, a coordinate descent, and a conjugate gradient process. The supervised machine learning model of insulation monitoring program 110 creates a loss function and utilizes gradient descent optimization to reduce the residual error between observed and actual confidence scores. Furthermore, insulation monitoring program 110 can also validate other supervised machine learning models like neural network regression and select an optimal test data accuracy model.

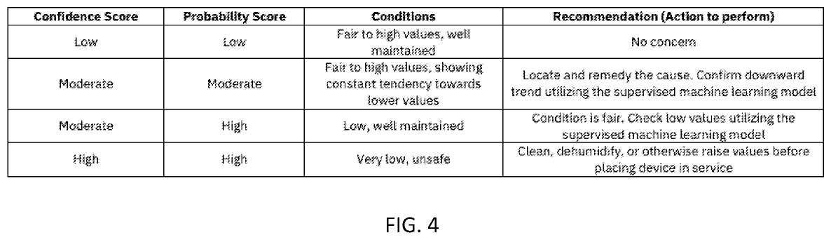

In one embodiment, insulation monitoring program 110 can utilize an example supervised machine learning model as defined below:

$$\begin{matrix}y = predicted confidence score \\ \overline{X} = vector measurements have features as shown \\ in the example table in Figure 4 \\ θ = Gradient to minimize , slope , or backward propagation error \\ p ( y \vert x , θ ) = N ( y \vert f ( x ) , {σ}^{2} ) \\ \text{=>} x ∈ {R}^{d} , y ∈ R and y = f ( x ) + ε , where ε = N ( 0 , {σ}^{2} ) \\ p ( y \vert x , θ ) = N ( y \vert x , θ , {σ}^{2} ) , where x is a vector of random variables \\ p ( y \vert x ) , is the likelihood of probability density function of y at {x}^{T} , \\ and hence y = {x}^{T} θ + ε \\ or alternatively , {y}_{i} = {θ}_{0} + {θ}_{1} {x}_{1} + {θ}_{2} {x}_{2} + {θ}_{3} {x}_{3} + … {e}_{i} \\ p ( y \vert x , θ ) = N ( y \vert x , θ , {σ}^{2} ) \\ taking log of both sides \\ - log P ( y {\vert}_{1} x , θ ) … = - log {\prod }_{n = 1}^{N} P ( {y}_{n} \vert {x}_{n} θ ) \\ \text{=>} - log P ( y \vert x , θ ) = - {\sum }_{n}^{N} log P ( {y}_{n} \vert {x}_{n} , θ ) \\ \text{=>} L ( θ ) = - log P ( y \vert x , θ ) = - log ( \frac{1}{\sqrt{2 π {σ}^{2}}} * {e}^{( \frac{{( y - {x}^{T} θ )}^{2}}{2 * {σ}^{2}}} ) \\ \text{=>} L ( θ ) = - \frac{1}{2 {σ}^{2}} {( {y}_{n} - {x}_{n}^{T} θ )}^{2} + {\sum }_{n = 1}^{N} log ( 1 / ( \sqrt{2 * π {σ}^{2} )} \\ \end{matrix}$$

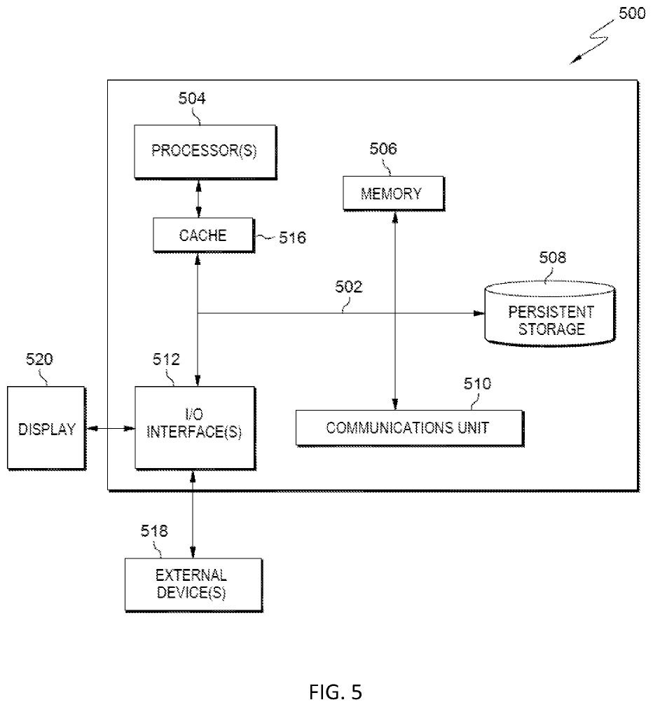

Insulation monitoring program 110 generates a decision framework for the electronic device based on the current leakage and confidence score (206). Insulation monitoring program 110 generates the decision framework for the electronic device for utilization when determining whether to perform an action. Insulation monitoring program 110 can utilizes various levels of confidence scores and probability scores, such as, low, moderate, and high for each cable powered electronic device with an insulation layer. Insulation monitoring program 110 can utilizes the confidence scores and probability scores to predict a condition for the insulation layer on the cable powered electronic device and provide an action performable by the client and/or technician maintaining the electronic device. Insulation monitoring program 110 provides the action performable by the client and/or technician in the form of an alert with summarized results from the supervised machine learning model and a recommendation for a varying degree of action. FIG. 5 illustrates an example table with the decision framework for multiple cable powered electronic devices.

Insulation monitoring program 110 determines whether to perform an action based on the generated decision framework (decision 208). In the event insulation monitoring program 110 determines to perform an action based on the generated decision framework (“yes” branch, decision 208), insulation monitoring program 110 performs an action based on the generated decision framework (210). In the event insulation monitoring program 110 determines not to perform an action based on the generated decision framework (“yes” branch, decision 208), insulation monitoring program 110 reverts to determined current leakage with confidence score for the insulation in a current state.

Insulation monitoring program 110 performs an action based on the generated decision framework (210). Insulation monitoring program 110 performs an action based on the generated decision framework to address the current leakage of the insulation layer for the cable powered electronic device. In one embodiment, insulation monitoring program 110 performs an action that includes sending a notification to the client and/or technician that the insulation layer on the cable powered electronic device is approaching hazardous conditions, where the notification details the negative impacts of the environment (e.g., high temperature values, high humidity values) and location (e.g., outdoors, direct sunlight) as a trigger for the notification and alert to action. Insulation monitoring program 110 allows for the client and/or technician to review the results of the supervised machine learning model in a table, as illustrated in an example in FIG. 4. In another embodiment, insulation monitoring program 110 performs an action that includes scheduling a maintenance inspection of the cable powered electronic device experiences a predicted insulation layer degradation. Insulation monitoring program 110 can schedule the maintenance inspection and provide a list of recommendation action items to correct and/or decelerate the degradation of the insulation layer of the cable powering the electronic device. The types of recommendation action items can include cleaning the insulation layer of debris, dehumidifying the insulation layer, visually inspecting the insulation layer for visible damage (e.g., cracking), visually inspecting the environment at the location, and confirming the degradation of the insulation layer via the supervised machine learning model.

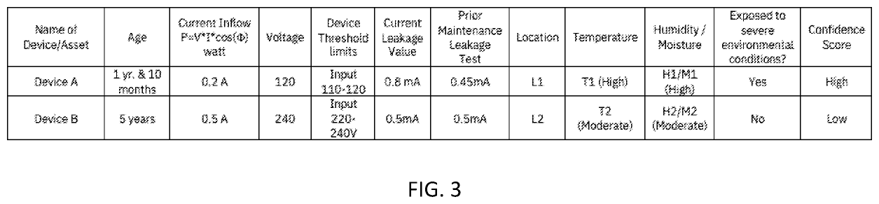

FIG. 3 illustrates an example table of determined current leakage with confidence scores for insulation associated with two devices, in accordance with an embodiment of the present invention. In this embodiment, Device A represents a first cable powered electronic device and Device B represents a second cable powered electronic device, where both Device A and Device B have experienced varying environmental conditions. For an electronic device that experiences severe environmental conditions, the electronic device becomes a candidate for a high probability where electrical insulation experiences accelerated degradation and deterioration if no action is taken by a client and/or technician. Though an age of Device A (i.e., 1 year and 10 months) is less than an age of Device B (i.e., 5 years), Device A has higher confidence score and higher probability for experiencing greater insulation degradation when compared to Device B which has a lower confidence score and lower probability for experiencing greater insulation degradation due to the environmental conditions. Device A is exposed to more severe environmental conditions when compared to Device B, since Device A is exposed to high temperatures (T1) and high humidity/moisture (H1/M1) and Device B is exposed to low temperatures (T2) and low humidity/moisture (H2/M2). For the supervised machine learning model, insulation monitoring program 110 takes into account a current leakage value and a prior maintenance leakage test value to see compare the two values over a period of time. Device A includes an insulation layer that has experienced a resistance drop of 0.35 mA versus Device B with an insulation layer that experience no resistance drop over the same period of time.

FIG. 4 illustrates an example table of a decision framework and recommendation policy for determined current leakage and confidence scores, in accordance with an embodiment of the present invention.

The decision framework that insulation monitoring program 110 generates includes various recommendations and actions performable by the client and/or technician with respect to the cable powered electronic device with insulation layer. For a low confidence score and a low probability score, where conditions include fair to high values for resistance values during the current leakage test, insulation monitoring program 110 recommends no action due to there being no concern with regards to the degradation of the insulation layer. For a moderate confidence score and a moderate probability score, where conditions include fair to high values for resistance values during the current leakage test showing constant tendency towards lower values, insulation monitoring program 110 recommends locating and remedying any issues resulting in the lower values. Furthermore, insulation monitoring program 110 recommends the client and/or technician confirm the tendency towards lower values (i.e., downward trend) utilizing the supervised machine learning model. For a moderate confidence score and a high probability score, where conditions include low and maintained resistance values during the current leakage test, insulation monitoring program 110 determines the condition is fair and recommends verifying the lower values utilizing the supervised machine learning model. For a high confidence score and a high probability score, where conditions include very low and unsafe resistance values during the current leakage test, insulation monitoring program 110 recommends the client and/or technician clean, dehumidify, or otherwise raise the resistance values for the insulation layer prior to placing the electronic device into service. The client and/or technician can raise the resistance values for the insulation layer by perform a repair on the insulation layer or replacing the insulation layer altogether.

FIG. 5 depicts a computer system, where server computer 102 is an example of a computer system that can include insulation prediction program 110. The computer system includes processors 504, cache 516, memory 506, persistent storage 508, communications unit 510, input/output (I/O) interface(s) 512 and communications fabric 502. Communications fabric 502 provides communications between cache 516, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses or a crossbar switch.

Memory 506 and persistent storage 508 are computer readable storage media. In this embodiment, memory 506 includes random access memory (RAM). In general, memory 506 can include any suitable volatile or non-volatile computer readable storage media. Cache 516 is a fast memory that enhances the performance of processors 504 by holding recently accessed data, and data near recently accessed data, from memory 506.

Program instructions and data used to practice embodiments of the present invention may be stored in persistent storage 508 and in memory 506 for execution by one or more of the respective processors 504 via cache 516. In an embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Program instructions and data used to practice embodiments of the present invention may be downloaded to persistent storage 508 through communications unit 510.

I/O interface(s) 512 allows for input and output of data with other devices that may be connected to each computer system. For example, I/0 interface 512 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention can be stored on such portable computer readable storage media and can be loaded onto persistent storage 508 via I/O interface(s) 512. I/O interface(s) 512 also connect to display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable

What is claimed is:

1. A computer-implemented method comprising:
determining a present insulation level for an insulation layer on a cable providing power to an electronic device based on a current leakage test;
determining a current leakage and a confidence score for the insulation layer on the cable providing power to the electronic device utilizing a supervised machine learning model;
generating a decision framework for the electronic device based on the current leakage and the confidence score; and
responsive to determining to perform an action based on the decision framework for the electronic device, performing the action based on the decision framework to address the current leakage for the insulation layer on the cable providing power to the electronic device.

2. The computer-implemented method of claim 1, wherein determining the current leakage and the confidence score further comprising:
calculating a present leakage value based on a different between a current leakage value and a prior maintenance leakage test value; and
predicting the current leakage and the confidence score based on electronic device data, weather data, maintenance data, and the present leakage value.

3. The computer-implemented method of claim 1, wherein determining the present insulation level for the insulation layer further comprises:
receiving, from an insulation tester, a plurality of resistance values over a period of time for the insulation layer, wherein the plurality of resistance values represents an initial data set for the supervised machine learning model; and
determining the present insulation level based on a dielectric absorption ratio.

4. The computer-implemented method of claim 1, wherein determining the present insulation level for the insulation layer further comprises:
receiving, from an insulation tester, a plurality of resistance values over a period of time for the insulation layer, wherein the plurality of resistance values represents an initial data set for the supervised machine learning model; and
determining the present insulation level based on a polarization index.

5. The computer-implemented method of claim 2, wherein performing the action based on the decision framework further comprising:
sending a notification to a client indicating the insulation layer is approaching a hazardous condition.

6. The computer-implemented method of claim 2, wherein performing the action based on the decision framework further comprising:
displaying results of the supervised machine learning model with the current leakage and the confidence score along with the electronic device data, the weather data, the maintenance data, and the present leakage value.

7. The computer-implemented method of claim 2, wherein performing the action based on the decision framework further comprising:
sending a notification to a client providing a recommendation to perform an action selected from the group consisting of: cleaning the insulation layer of debris, dehumidifying the insulation layer, visually inspecting the insulation layer for visible damage, visually inspecting an environment at a location for the electronic device, and confirming degradation of the insulation layer via results for the supervised machine learning model.

8. A computer program product comprising:
one or more computer-readable storage media and program instructions stored on the one or more computer-readable storage media capable of performing a method, the method comprising:
determining a present insulation level for an insulation layer on a cable providing power to an electronic device based on a current leakage test;
determining a current leakage and a confidence score for the insulation layer on the cable providing power to the electronic device utilizing a supervised machine learning model;
generating a decision framework for the electronic device based on the current leakage and the confidence score; and
responsive to determining to perform an action based on the decision framework for the electronic device, performing the action based on the decision framework to address the current leakage for the insulation layer on the cable providing power to the electronic device.

9. The computer program product of claim 8, wherein determining the current leakage and the confidence score further comprising:
calculating a present leakage value based on a different between a current leakage value and a prior maintenance leakage test value; and
predicting the current leakage and the confidence score based on electronic device data, weather data, maintenance data, and the present leakage value.

10. The computer program product of claim 8, wherein determining the present insulation level for the insulation layer further comprises:
receiving, from an insulation tester, a plurality of resistance values over a period of time for the insulation layer, wherein the plurality of resistance values represents an initial data set for the supervised machine learning model; and
determining the present insulation level based on a dielectric absorption ratio.

11. The computer program product of claim 8, wherein determining the present insulation level for the insulation layer further comprises:
receiving, from an insulation tester, a plurality of resistance values over a period of time for the insulation layer, wherein the plurality of resistance values represents an initial data set for the supervised machine learning model; and
determining the present insulation level based on a polarization index.

12. The computer program product of claim 9, wherein performing the action based on the decision framework further comprising:
sending a notification to a client indicating the insulation layer is approaching a hazardous condition.

13. The computer program product of claim 9, wherein performing the action based on the decision framework further comprising:
displaying results of the supervised machine learning model with the current leakage and the confidence score along with the electronic device data, the weather data, the maintenance data, and the present leakage value.

14. The computer program product of claim 9, wherein performing the action based on the decision framework further comprising:
sending a notification to a client providing a recommendation to perform an action selected from the group consisting of: cleaning the insulation layer of debris, dehumidifying the insulation layer, visually inspecting the insulation layer for visible damage, visually inspecting an environment at a location for the electronic device, and confirming degradation of the insulation layer via results for the supervised machine learning model.

15. A computer system comprising:
one or more computer processors, one or more computer-readable storage media, and program instructions stored on the one or more of the computer-readable storage media for execution by at least one of the one or more processors capable of performing a method, the method comprising:
determining a present insulation level for an insulation layer on a cable providing power to an electronic device based on a current leakage test;
determining a current leakage and a confidence score for the insulation layer on the cable providing power to the electronic device utilizing a supervised machine learning model;
generating a decision framework for the electronic device based on the current leakage and the confidence score; and
responsive to determining to perform an action based on the decision framework for the electronic device, performing the action based on the decision framework to address the current leakage for the insulation layer on the cable providing power to the electronic device.

16. The computer system of claim 15, wherein determining the current leakage and the confidence score further comprising:
calculating a present leakage value based on a different between a current leakage value and a prior maintenance leakage test value; and
predicting the current leakage and the confidence score based on electronic device data, weather data, maintenance data, and the present leakage value.

17. The computer system of claim 15, wherein determining the present insulation level for the insulation layer further comprises:
receiving, from an insulation tester, a plurality of resistance values over a period of time for the insulation layer, wherein the plurality of resistance values represents an initial data set for the supervised machine learning model; and
determining the present insulation level based on a dielectric absorption ratio.

18. The computer system of claim 15, wherein determining the present insulation level for the insulation layer further comprises:
receiving, from an insulation tester, a plurality of resistance values over a period of time for the insulation layer, wherein the plurality of resistance values represents an initial data set for the supervised machine learning model; and
determining the present insulation level based on a polarization index.

19. The computer system of claim 16, wherein performing the action based on the decision framework further comprising:
sending a notification to a client indicating the insulation layer is approaching a hazardous condition.

20. The computer system of claim 16, wherein performing the action based on the decision framework further comprising:
displaying results of the supervised machine learning model with the current leakage and the confidence score along with the electronic device data, the weather data, the maintenance data, and the present leakage value
